(19) United States
(12) Patent Application Publication
(10) Pub. No.: US 2024/0166821 A1
(43) Pub. Date: May 23, 2024

(54) FLAME RETARDANT COMPOUNDS

(71) Applicant: FUNZIONANO AS, Porsgrunn (NO)

(72) Inventors: Morten Eikenes, Sandefjord (NO); Dag Høvik, Porsgrunn (NO); Matthew Read, Urenui, Taranaki (NZ); Tonje Haagensen, Langangen (NO); Samer Sahli, Porsgrunn (NO); Annie Rose Knutsen, Skien (NO); Siri Heggheim, Porsgrunn (NO); Ivan Kotek, Porsgrunn (NO)

(73) Assignee: Bioenvision Technology AS, Porsgrunn (NO)

(21) Appl. No.: 18/549,752

(22) PCT Filed: Dec. 14, 2021
(86) PCT No.: PCT/EP2021/085662

§ 371 Date: Sep. 8, 2023

(30) Foreign Application Priority Data
Mar. 10, 2021 (NO) 20210311

(51) Int. Cl. C08G 77/26; C08G 77/04; C08L 83/08

(52) U.S. Cl. CPC C08G 77/26; C08G 77/045; C08L 83/08; C08L 2201/02

(57) ABSTRACT

A silsesquioxane of formula: (R₁SiO_{1,5})ₓ(R₂SiO_{1,5})_{y}(R₃SiO_{1,5})_{z}, wherein x≥1, y≥1, z≥1, and x+y+z=6, 8, 10 or 12. R₁ is L₁-phthalimide, wherein L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and the phthalimide is optionally substituted by one or more halogen, C₁-C₆ alkyl, —COOH, —OH or —NO₂. R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens. R₃ is L₂-NH—CO—R₄, wherein L₂ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and wherein R₄ is a C₁-C₃₄ alkyl or a C₈-C₃₄ alkene.

### FIELD OF THE INVENTION

The present invention relates to fire retardants and more specifically to novel functionalized polyhedral oligomeric silsesquioxanes (POSS) and their use as fire retardants in polymeric materials.

### BACKGROUND OF THE INVENTION

Many common polymeric materials used in our daily life are highly flammable thereby increasing their risk as fire hazards when used in practical applications. Consequently, improving polymer fire retardancy is a major challenge for extending polymer use to most applications.

Halogen-containing compounds are well known to be effective fire retardants for polymers, however, due to environmental concerns the use of halogen-containing fire retardants have been gradually prohibited (Environ Health Perspect., 2004, 112, pages 9-17).

An alternative to the use of halogen-containing compounds are phosphorus-based fire retardants. However, many phosphorus-based fire retardants will plasticize the polymers, thereby reducing modulus, glass transition temperature and strength. There are also environmental concerns associated with some phosphorus-based fire retardants (Fire Sci. 2004, 22, pages 293-303).

Further, the occurrence and environmental behaviour of organophosphorus compounds in diverse matrices have been reviewed by Wei et al (Environ Pollut., 2015, 196, pages 29-46)

Thus, there is a continuous need for developing safe and eco-friendly fire retardants that are compatible with being incorporated into polymer matrices.

Reinforcing polymers with nanosized fillers, such as carbon nanotubes or nanoclay, represents a promising methodology for providing safe and eco-friendly fire retardants. Following this approach, improvements in fire retardance may be found even at relatively low filler content.

Montmorillonite is the most commonly used clay because it is naturally ubiquitous, can be obtained at high purity and low cost, and exhibits very rich intercalation chemistry, meaning that it can be easily organically modified. The natural clay surface is hydrophilic, so the clay easily disperses in aqueous solutions but not in polymers. Natural clays are therefore often modified using organic cations such as alkylammonium and alkylphosphonium cations, forming hydrophobic organo-modified clays that can be readily dispersed in polymers. However, there are no covalent bonds between the organic cations and the nanoclay.

An alternative to the use of carbon nanotubes and nanoclay is physically or chemically incorporating polyhedral oligomeric silsesquioxanes (POSS) into common polymer systems to offer hybrid composites with improved fire-retardant properties. POSS are a kind of inorganic-organic hybrid compounds which nanostructures have become attractive because of their environmental neutrality, good heat resistance as well as excellent thermoxidative stability (New York: Springer Netherlands; 2011, pages 209-228).

POSS have the general formula (RSiO_{1.5})ₙ, where R represents an organic functionality and n is commonly 6, 8 10 or 12. A POSS wherein n is 8 is shown in FIG. 1. Although often represented by a single structure as in FIG. 1, the product(s) obtained in the synthesis of POSS is usually a mixture of the different closed cage structures according to the general formula, as well as minor amounts of not fully closed structures depending on the nature of the R-groups. These cage structures combine unique hybrid (inorganic-organic) chemical compositions with nanosized cage structures of approximately 1.5 nm in diameter (the R-groups being included). They can be loosely regarded as the smallest possible silica particles. However, unlike silica and nanoclay, each POSS molecule has organic functionalities covalently bound to their outer surface which may provide solubility and compatibility of the POSS with various polymer systems.

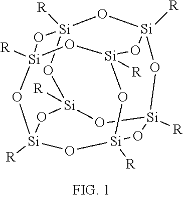

Even though several different polymer POSS-composites have been shown to be associated with enhanced fire retardancy (progress in polymer science, 67, 2017, pages 77-125), it is essential that the incorporation of POSS into the polymer system does not negatively affect the other physical properties of the polymer, in particular the mechanical properties of the polymer system.

Variations in the POSS R-functionalities have previously been found to determine the interactions between the POSS moiety and the host polymer segments and this, in turn, has been found to impact microstructure and rheology (Journal of Macromolecular Science, Part C: Polymer Reviews, 49: 25-63, 2009). Without being bound by theory, it is believed that the selection of R-functionalities is essential both with respect to fire retardancy and the other physical properties of the polymer POSS-composite.

Incorporation of POSS in a monomer mixture to obtain a polymer POSS composite is not trivial since the properties of the POSS must allow it to be intimately blended with the monomer before polymerization occurs.

The aim of present invention is to provide novel POSS compounds having excellent properties as fire retardants, while offering improved solubility properties in plasticizers allowing them to be homogenously dispersed in various polymer blends.

### SUMMARY OF THE INVENTION

The present invention is defined by the appended claims and in the following:

In a first aspect, the present invention provides a silsesquioxane of formula:

(R₁SiO_{1,5})ₓ(R₂SiO_{1,5})_{y}(R₃SiO_{1,5})_{z}, wherein
x≥1, y≥1, z≥1, and x+y+z=6, 8, 10 or 12;
R₁ is L₁-phthalimide, wherein L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and the phthalimide is optionally substituted by one or more halogen, C₁-C₆ alkyl, —COOH, —OH or —NO₂;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens;
and
R₃ is L₂-NH—CO—R₄, wherein L₂ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and wherein R₄ is a C₁-C₃₄ alkyl or a C₈-C₃₄ alkene.

The term “the carbon chains of said residues optionally include one or more of the elements oxygen and nitrogen” is intended to mean that the carbon chains may include an ether moiety R—O—R or a secondary amine moiety R—NH—R.

In an embodiment of the silsesquioxane according to the first aspect, L₁ may be C₁-C₆ alkyl, phenyl or vinyl.

In an embodiment of the silsesquioxane according to the first aspect, R₂ may be a C₁-C₁₈ alkyl, a C₂-C₇ alkene or a phenyl group, optionally substituted by one or more halogens.

In an embodiment of the silsesquioxane according to the first aspect, R₂ may be a C₁-C₈ alkyl, a C₂-C₅ alkene or a phenyl group, optionally substituted by one or more halogens.

In an embodiment of the silsesquioxane according to the first aspect, L₂ may be a C₁-C₆ alkyl, phenyl or vinyl.

In an embodiment of the silsesquioxane according to the first aspect, R₄ may be a C₈-C₃₄ alkyl or a C₁₂-C₂₄ alkene.

In an embodiment of the silsesquioxane according to the first aspect, R₄ may be a C₁₂-C₂₄ alkyl or a C₁₂-C₂₄ alkene.

In an embodiment of the silsesquioxane according to the first aspect, R₄ may be a C₁₈-C₂₂ alkyl or a C₁₈-C₂₂ alkene.

In an embodiment of the silsesquioxane according to the first aspect L₁ and L₂ may be identical. In other words, L₁ is equal to L₂.

In an embodiment of the silsesquioxane according to the first aspect, L₁ and L₂ may both be a C₁-C₆ alkyl, and R₂ is a C₁-C₈ alkyl, a C₁-C₇ alkene or a phenyl group.

In an embodiment of the silsesquioxane according to the first aspect, R₄ may be derived from a suitable fatty acid, such as stearic acid, lauric acid, behenic acid or soya acid.

In a second aspect, the present invention provides a silsesquioxane of formula:

(H₂N-L₁-SiO_{1,5})ₓ(R₂SiO_{1,5})_{y}, wherein
x≥2, y≥2, and x+y=6, 8, 10 or 12;
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens.

In an embodiment of the silsesquioxane according to the second aspect, L₁ and R₂ may be as defined for any embodiment of the first aspect.

In a third aspect, the present invention provides for the use of a silsesquioxane according to the first or second aspect as a flame retardant additive.

The flame retardant additive may be added to any suitable material in need thereof, such as any suitable polymeric material, including thermoplastic, thermoset or elastomeric polymeric materials, for instance selected from the group comprising polyvinyl chloride (PVC), polyethylene (PE), polyurethane (PU), polyamides (PA), polypropylene (PP), epoxides, various polyesters and polystyrene (PS). The flame retardant additive may advantageously be used in combination with an inorganic flame retardant additive, such as aluminium trihydrate (ATH) or antimony trioxide.

In a fourth aspect, the present invention provides a plasticizer composition comprising:
a) 50-99 wt % of a plasticizer; and
b) 1-50 wt % of a silsesquioxane according to the first or second aspect;
wherein
the plasticizer is selected from a dicarboxylic/tricarboxylic ester-based plasticizers selected from the group of phthalates, 1,2-cyclohexane dicarboxylates, trimellitates, adipates, sebacates, maleates, terephthalates or any combination thereof, and
wherein the combined wt % of the plasticizer and the silsesquioxane is within the range of 90-100 wt % of the total weight of the plasticizer composition.

In an embodiment of the fourth aspect, the plasticizer composition comprises 1-10 or 1-5 wt % of the silsesquioxane according to the first or second aspect.

In a fifth aspect, the present invention provides a polymeric material comprising a silsesquioxane according to the first or second aspect or a plasticizer composition according to the fourth aspect. The polymeric material may be a thermoplastic, thermoset or elastomer, for instance selected from the group comprising polyvinyl chloride (PVC), polyethylene (PE), polyurethane (PU), polyamides (PA), polypropylene (PP), epoxides, various polyesters and polystyrene (PS). The polymeric material may advantageously comprise an inorganic flame retardant additive, such as aluminium trihydrate (ATH) or antimony trioxide.

In a sixth aspect, the present invention provides a method of manufacturing a silsesquioxane according to the first aspect or a composition according to the fourth aspect comprising the steps of:
condensing a compound of formula H₂N-L₁-Si(OR₅)₃ and a compound of formula R₂Si(OR₆)₃ in a mole ratio of 0.25 to 4, wherein
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens; and
each of R₅ and R₆ are any of —CH₃ and —CH₂CH₃;
obtaining an intermediate silsesquioxane of formula (H₂N-L₁-SiO_{1,5})ₓ(R₂SiO_{1,5})_{y}, wherein
   x≥2, y≥2, and x+y=6, 8, 10 or 12;
reacting the intermediate silsesquioxane with a first compound of formula LG-CO—R₄, wherein LG is a suitable leaving group and R₄ is a C₁-C₃₄ alkyl or a C₈-C₃₄ alkene, and a second compound being phthalic anhydride optionally substituted by one or more halogen, C₁-C₈ alkyl, —COOH, —OH or —NO₂; and
obtaining a silsesquioxane according to the first aspect.

In an embodiment of the sixth aspect, the mole ratio of the compound of formula H₂N-L₁-Si(OR₅)₃ and the compound of formula R₂Si(OR₆)₃ is 0.4 to 2.5.

In an embodiment of the sixth aspect, the method comprises a step of adding the obtained silsesquioxane to a suitable plasticizer to obtain a composition according to the fourth aspect.

In an embodiment of the sixth aspect, the first compound is added in a mole ratio of 0.2 to 0.8, 0.3 to 0.7 or 0.4 to 0.6 relative to the compound of formula H₂N-L₁-Si(OR₅)₃.

In an embodiment of the sixth aspect, the first compound is added in a mole ratio of 0.1 to 0.6 relative to the intermediate silsesquioxane.

In an embodiment of the sixth aspect, the second compound is added in a mole ratio of 0.2 to 0.8, 0.3 to 0.7 or 0.4 to 0.6 relative to the compound of formula H₂N-L₁-Si(OR₅)₃.

In an embodiment of the sixth aspect, the second compound is added in a mole ratio of 0.1 to 0.6 relative to the intermediate silsesquioxane.

In an embodiment of the silsesquioxane according to the sixth aspect, the first compound may be a suitable fatty acid, such as stearic acid, lauric acid, behenic acid or soya acid.

In a seventh aspect, the present invention provides a method of manufacturing a silsesquioxane according to the second aspect, or a composition according to the fourth aspect, comprising the steps of:
condensing a compound of formula H₂N-L₁-Si(OR₅)₃ and a compound of formula R₂Si(OR₆)₃ in a mole ratio of 0.25 to 4, wherein
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens; and
each of R₅ and R₆ are any of —CH₃ and —CH₂CH₃; and
obtaining a silsesquioxane according to the second aspect.

In a seventh aspect, the present invention provides a silsesquioxane obtainable by the method according to the sixth or seventh aspect.

As used herein, the terms “alkyl” and “alkene” are intended to encompass straight chained, cyclic and branched alkyls and alkenes, respectively.

In other words, a C₁-C₁₈ alkyl may for instance be a methyl ethyl, propyl, sec-propyl, n-butyl, t-butyl, sec-butyl, pentyl, cyclopentyl, hexyl, cyclohexyl, octyl or octadecyl.

### DETAILED DESCRIPTION OF THE INVENTION

Unless specifically defined herein, all technical and scientific terms used have the same meaning as commonly understood by a skilled artisan in the fields of organic chemistry and polymer technology.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will prevail.

Where a numerical limit or range is stated herein, the endpoints are included. Also, all values and sub ranges within a numerical limit or range are specifically included as if explicitly written out.

The background for the present invention was the desire to provide novel POSS compounds having improved fire retardancy and appropriate solubility for incorporation into polymer blends. The novel POSS should preferably not have any negative impact upon the mechanical properties of the final polymeric material.

The suitability of the novel POSS compounds for homogenous blending with plasticizers well-known in the polymer industry is of particular interest. By dissolving the POSS into a plasticizer before mixing the plasticizer with a suitable polymer monomer, the novel POSS may be incorporated into polymers wherein compatibility would otherwise be an issue. The suitability of the novel POSS compounds for blending with plasticizers is predominantly ensured by the defined combination of substituents.

As described above, the POSS compounds according to the present invention are particularly suitable for blending with a plasticizer before being added to a desired monomer. Suitable plasticizers for dissolving the inventive POSS compounds are for instance phthalate esters, such as diisononyl phthalate (DINP) and analogous 1,2-cyclohexane dicarboxylic esters, such as 1,2-Cyclohexane dicarboxylic acid diisononyl ester (DINCH). Almost 90% of plasticizers are used in PVC, giving this material improved flexibility and durability. For plastics such as PVC, the more plasticizer added, the lower their cold flex temperature will be. Plastic items containing plasticizers can exhibit improved flexibility and durability.

To obtain a desired solubility of POSS in various plasticizers, in particular plasticizers for PVC, the applicant hypothesised that a POSS compound having a suitable combination of substituents comprising both short and long carbon chains would be advantageous. Further, at least one of the substituents should comprise an phthalimide to optimize the flame retardant properties.

Having generally described this invention, a further understanding can be obtained by reference to certain specific examples, which are provided herein for purposes of illustration only, and are not intended to be limiting unless otherwise specified.

### Experimental Procedures

The synthesis of exemplary POSS compounds according to the invention, as well as comparative POSS compounds are described below.

As discussed above, the POSS compounds are commonly obtained as mixtures of different closed cage structures.

A Bruker 400 MHz NB Avance III UltraShielded Plus instrument was used to obtain ¹H-NMR, ¹³C-NMR and ²⁹Si-NMR spectra for a selection of the isolated POSS compounds. Due to the mixture of compounds the spectra are quite complex, but ²⁹Si-NMR showed only shifts belonging to closed cage structures, i.e. no open structures were detected.

### Exemplary POSS Compounds

### Comparative Starting Compound

### Example 1.1 (Amino-POSS)

In a 3 L reactor with a temperature adjustable heat jacket, stirrer, thermometer, dropping funnel, vertical cooler with column head for rapid exchange between reflux and distillation, and vacuum connection (membrane pump). A mixture of 800 g (3.61 mol) of (3-aminopropyl) triethoxysilane, 880 g (14.65 mol) 1-propanol, and 130 g (7.23 mol) water where added to the reaction vessel. The resulting mixture was purged using nitrogen gas and vacuum 3 times. The reaction mixture was then heated with reflux for 2 h (at std. atmospheric pressure). The volatile reaction products and solvents where then removed by distillation. When approx. 750 g of volatile reaction product and solvents where removed 1200 g xylene was added, and distillation continued until the boiling point of xylene was reached. In total 2212 g of volatile reaction product and solvent was removed resulting in a 399 g (3.61 mol) amino-POSS and 399 g of xylene in the final mixture, 798 g of 50 wt % solution of amino-POSS in xylene.

In the synthesis of the Amino-POSS, the solvent xylene may be replaced by propanol and distillation temperature amended accordingly.

### Starting Compounds According to the Invention

### Example 1.2 (Amino-Propyl-POSS)

In a 3 L reactor with a temperature adjustable heat jacket, stirrer, thermometer, dropping funnel, vertical cooler with column head for rapid exchange between reflux and distillation, and vacuum connection (membrane pump). A mixture of 625 g (2.82 mol) of (3-aminopropyl) triethoxysilane, 583 g (2.82 mol) triethoxy(propyl)silane, 687 g (11.4 mol) 1-propanol, and 203 g (11.29 mol) water where added to the reaction vessel. The resulting mixture was purged using nitrogen gas and vacuum 3 times. The reaction mixture was then heated with reflux for 16 h (at std. atmospheric pressure). The volatile reaction products and solvents where then removed by distillation. When approx. 1000 g of volatile reaction product and solvents where removed 1200 g xylene was added, and distillation continued until the boiling point of xylene was reached. In total 2138 g of volatile reaction product and solvent was removed resulting in a 581 g (5.65 mol) amino-propyl-POSS and 581 g of xylene in the final mixture, 1162 g of 50 wt % solution of amino-propyl-POSS in xylene. ²⁹Si-NMR of the obtained product showed predominantly peaks at −65 to −70 ppm indicating fully condensed cage structures.

In the synthesis of the Amino-Propyl-POSS, the solvent xylene may be replaced by 1-metoxy-2-propanol and distillation temperature amended accordingly.

### Example 1.3 (Amino-Phenyl-POSS)

In a 10 L reactor with a temperature adjustable heat jacket, stirrer, thermometer, dropping funnel, vertical cooler with column head for rapid exchange between reflux and distillation, and vacuum connection (membrane pump). A mixture of 443 g (2.00 mol) of (3-aminopropyl) triethoxysilane, 192 3 g (8.00 mol) triethoxy(phenyl)silane, 2432 g (40.46 mol) 1-propanol, and 360 g (20.00 mol) water where added to the reaction vessel. The resulting mixture was purged using nitrogen gas and vacuum 3 times. The reaction mixture was then heated with reflux for 16 h (at std. atmospheric pressure). The volatile reaction products and solvents where then removed by distillation. When approx. 3000 g of volatile reaction product and solvents where removed 4500 g xylene was added, and distillation continued until the boiling point of xylene was reached. In total 7148 g of volatile reaction product and solvent was removed resulting in a 1256 g (10 mol) amino-phenyl-POSS and 1256 g of xylene in the final mixture, 2512 g of 50 wt % solution of amino-phenyl-POSS in xylene.

### Example 1.4 (Amino-Vinyl-POSS)

In a 3 L reactor with a temperature adjustable heat jacket, stirrer, thermometer, dropping funnel, vertical cooler with column head for rapid exchange between reflux and distillation, and vacuum connection (membrane pump). A mixture of 400 g (1.81 mol) of (3-aminopropyl) triethoxysilane, 344 g (1.81 mol) triethoxy(vinyl)silane, 880 g (14.64 mol) 1-propanol, and 130 g (7.23 mol) water where added to the reaction vessel. The resulting mixture was purged using nitrogen gas and vacuum 3 times. The reaction mixture was then heated with reflux for 16 h (at std. atmospheric pressure). The volatile reaction products and solvents where then removed by distillation. When approx. 1200 g of volatile reaction product and solvents where removed 1200 g xylene was added, and distillation continued until the boiling point of xylene was reached. In total 2318 g of volatile reaction product and solvent was removed resulting in a 343 g (3.62 mol) amino-Vinyl-POSS and 343 g of xylene in the final mixture, 686 g of 50 wt % solution of amino-Vinyl-POSS in xylene.

### Example 1.5 (Amino-Octyl-POSS)

In a 3 L reactor with a temperature adjustable heat jacket, stirrer, thermometer, dropping funnel, vertical cooler with column head for rapid exchange between reflux and distillation, and vacuum connection (membrane pump). A mixture of 400 g (1.81 mol) of (3-aminopropyl) triethoxysilane, 500 g (1.81 mol) triethoxy(octyl)silane, 880 g (14.64 mol) 1-propanol, and 130 g (7.23 mol) water where added to the reaction vessel. The resulting mixture was purged using nitrogen gas and vacuum 3 times. The reaction mixture was then heated with reflux for 16 h (at std. atmospheric pressure). The volatile reaction products and solvents where then removed by distillation. When approx. 1000 g of volatile reaction product and solvents where removed 1200 g xylene was added, and distillation continued until the boiling point of xylene was reached. In total 2114 g of volatile reaction product and solvent was removed resulting in a 498 g (3.61 mol) amino-octyl-POSS and 498 g of xylene in the final mixture, 996 g of 50 wt % solution of amino-octyl-POSS in xylene.

### Example 1.6 (Amino-Propyl-POSS)

In a 3 L reactor with a temperature adjustable heat jacket, stirrer, thermometer, dropping funnel, vertical cooler with column head for rapid exchange between reflux and distillation, and vacuum connection (membrane pump). A mixture of 500 g (2.26 mol) of (3-aminopropyl) triethoxysilane, 155 g (0.75 mol) triethoxy(propyl)silane, 550 g (9.15 mol) 1-propanol, and 108 g (6.02 mol) water where added to the reaction vessel. The resulting mixture was purged using nitrogen gas and vacuum 3 times. The reaction mixture was then heated with reflux for 16 h (at std. atmospheric pressure). The volatile reaction products and solvents where then removed by distillation. When approx. 1000 g of volatile reaction product and solvents where removed 1200 g 1-metoxy-2-propanol was added, and distillation continued until the boiling point of 1-metoxy-2-propanol was reached. In total 2138 g of volatile reaction product and solvent was removed resulting in a 321 g (3.01 mol) amino-propyl-POSS and 321 g of 1-metoxy-2-propanol in the final mixture, 642 g of 50 wt % solution of amino-propyl-POSS in 1-metoxy-2-propanol.

All starting compounds could be isolated in close to quantitative yield by distilling/evaporating off the volatiles of the reaction mixture.

### POSS Compounds According to the Invention

SF453

To 1162 g of a product (50 wt % amino-propyl-POSS in xylene) obtained according to example 1.2, 1500 g xylene and 402 g (1.41 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (25 g), the reaction was cooled to 80° C. 209 g (1.41 mol) phthalic anhydride chips was added and the reaction mixture heated at 130° C. for 2 h. ²⁹Si-NMR of the obtained product showed only peaks between −65 to −71 ppm indicating fully condensed cage structures.

SF457

To the 1162 g product (50 wt % amino-propyl-POSS in xylene) obtained according to example 1.2, 1500 g xylene and 241 g (0.85 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (15.2 g), the reaction was cooled to 80° C. 293 g (1.98 mol) phthalic anhydride chips was added and the reaction mixture heated at 130° C. for 2 h.

SF468

To the 2512 g product (50 wt % solution of amino-phenyl-POSS in xylene) obtained according to example 1.3. 3000 g xylene and 356 g (1.25 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (23 g), the reaction was cooled to 80° C. 111 g (0.75 mol) phthalic anhydride chips was added and the reaction mixture heated at 130° C. for 2 h.

²⁹Si-NMR of the obtained product showed only peaks between −65 to −71 ppm and between −77 to −82 ppm, indicating fully condensed cage structures.

SF506

To the 686 g product (50 wt % amino-Vinyl-POSS in xylene) obtained according to example 1.4, 1000 g xylene and 254 g (0.90 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (16 g), the reaction was cooled to 80° C. 134 g (0.9 mol) phthalic anhydride chips was added and the reaction mixture heated at 130° C. for 2 h.

SF460

To the 1162 g product (50 wt % amino-propyl-POSS in xylene) obtained according to example 1.2, 1500 g xylene and 397 g (1.41 mol) soya acid were added. The reaction mixture was heated at reflux and water was distilled off as an azeotropic mixture with xylene using a Dean-Stark trap with a volume of 50 ml. When the amount of water distilled off was equal to the calculated yield (25 g), the reaction was cooled to 80° C. 209 g (1.41 mol) phthalic anhydride chips was added and the reaction mixture heated at 130° C. for 2 h.

²⁹Si-NMR of the obtained product showed only peaks between −65 to −71 ppm, indicating fully condensed cage structures.

SF456

To 1162 g of a product (50 wt % amino-propyl-POSS in xylene) obtained according to example 1.2, 1500 g xylene and 804 g (2.83 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (51 g).

SF400

To 996 g of a product (50 wt % amino-octyl-POSS in xylene) obtained according to example 1.5, 900 g xylene and 257 g (0.9 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (16 g), the reaction was cooled to 80° C. 134 g (0.9 mol) phthalic anhydride chips was added and the reaction mixture heated at 130° C. for 2 h.

FN400126

To 642 g of a product (50 wt % amino-propyl-POSS in 1-metoxy-2-propanol) obtained according to example 1.6, 642 g 1-metoxy-2propanol and 115 g (0.75 mol) salicylic acid were added. The reaction mixture was heated at reflux and methanol was distilled off. When the amount of methanol distilled off was equal to the calculated yield (24 g), the reaction was cooled to 80° C. 66 g (0.75 mol) ethylene carbonate was added and the reaction mixture was kept at 80° C. for 2 h. Then 111.5 g (0.75 mol) phthalic anhydride chips was added. When phthalic anhydride was dissolved, xylene was added, and 1-metoxy-2-propanol was distilled off until the temperature in the mixture reaches 130° C. The reaction mixture was kept at 130° C. for 2 h.

FN400127

To 1116 g of a product (50 wt % amino-propyl-POSS in 1-metoxy-2-propanol) obtained according to example 1.2, 1394 g 1-metoxy-2propanol and 119 g (1.36 mol) ethylene carbonate were added. The reaction mixture was heated to 80° C. and kept at 80° C. for 2 h. Then 201 g (1.36 mol) phthalic anhydride chips was added. When phthalic anhydride was dissolved, xylene was added, and 1-metoxy-2-propanol was distilled off until the temperature in the mixture reaches 130° C. The reaction mixture was kept at 130° C. for 2 h.

FN400151

To 1116 g of a product (50 wt % amino-propyl-POSS in 1-metoxy-2-propanol) obtained according to example 1.2, 1394 g 1-metoxy-2propanol and 48 g (0.54 mol) ethylene carbonate were added, the reaction mixture was heated to 80° C. and kept at 80° C. for 2 h. Then 321 g (2.17 mol) phthalic anhydride chips was added. When phthalic anhydride was dissolved, xylene was added, and 1-metoxy-2-propanol was distilled off until the temperature in the mixture reaches 130° C. The reaction mixture was kept at 130° C. for 2 h.

All POSS compounds according to the invention could be isolated in close to quantitative yield by distilling/evaporating off the volatiles of the reaction mixture.

### Comparative POSS Compounds

SF406

To 798 g of a product (50 wt % amino-POSS in xylene) obtained according to example 1.1, 1000 g xylene and 308 g (0.9 mol) behenic acid were added. The reaction mixture was heated at reflux and water was distilled off as an azeotropic mixture with xylene using a Dean-Stark trap with a volume of 50 ml. When the amount of water distilled off was equal to the calculated yield (16 g), the reaction was cooled to 50° C. and 92 g (0.9 mol) acetic anhydride was added slowly. When the reaction had stopped generating heat the reaction mixture was heated to 80° C., and 268 g (1.81 mol) phthalic anhydride chips was added. The reaction mixture was heated to 130° C. for 2 h.

The reaction was considered complete after the residual amine was below 5 mg KOH/g sample.

Acetic acid residues from the reaction where removed by co-distillation with 3*100 ml additions of water to the reaction mixture.

SF427

To 798 g of a product (50 wt % amino-POSS in xylene) obtained according to example 1.1, 1000 g xylene and 1027 g (3.61 mol) stearic acid were added. The reaction mixture was heated at reflux and water was distilled off as an azeotropic mixture with xylene using a Dean-Stark trap with a volume of 50 ml. When the amount of water distilled off was equal to the calculated yield (65 g).

SF205

To 798 g of 50 wt % solution of amino-POSS in xylene product obtained according to example 1.1 1000 g of xylene and 307 g (0.9 mol) behenic acid were added. The reaction mixture was heated at reflux and water was distilled off as an azeotropic mixture with xylene, using a Dean-Stark trap with a volume of 50 ml. When the amount of water distilled off was equal to the calculated yield (16 g), 493 g (2.71 mol) glycol salicylate was added, and the reaction mixture heated at reflux for 16 h.

SF228

To 798 g of 50 wt % solution of amino-POSS in xylene product obtained according to example 1.1 1000 g of xylene and 513 g (1.81 mol) stearic acid were added. The reaction mixture was heated at reflux and water was distilled off as an azeotropic mixture with xylene, using a Dean-Stark trap with a volume of 50 ml. When the amount of water distilled off was equal to the calculated yield (32 g), 330 g (1.81 mol) glycol salicylate was added, and the reaction mixture heated at reflux for 16 h.

FN400120

To 9620 g of a product (50 wt % amino-POSS in propanol) obtained according to example 1.1, 8000 g propanol and 3315 g (21.79 mol) methylsalicylate were added. The reaction mixture was heated at reflux and methanol was distilled off When the amount of methanol distilled off was equal to the calculated yield (698 g), the reaction was cooled to 80° C. and 959 g (10.89 mol) ethylene carbonate was added slowly. When the reaction had stopped generating heat the reaction mixture was heated to 80° C., and 1613 g (10.89 mol) phthalic anhydride chips was added. When phthalic anhydride was dissolved, xylene was added, and propanol was distilled off until the temperature in the mixture reaches 130° C. The reaction mixture was heated to 130° C. for 2 h.

All comparative POSS compounds could be isolated in close to quantitative yield by distilling/evaporating off the volatiles of the reaction mixture.

Determining when Reactions where Complete:

All reactions where considered complete when they reached a residual amine number below 10 but more preferably below 5, as determined by the following method: A known amount of the material was dissolved in either 2-butoxy ethanol or chlorobenzene 10 mL and 50 mL of glacial acetic acid. This mixture was titrated with a 0.10 molar solution of HClO₄ in acetic acid.

The below formula is used to calculate the amine number:

$$\frac{ml titrated \times 5 , 61}{( Measured sample \times TS )}$$

For example: if the equivalence point is observed when titrated 4.1 ml of the 0.10 M HClO₄ with a POSS sample of 1.203 g and TS % content 51.33% (0.5133)

$$TBN = \frac{4 , 1 \times 5 , 61}{1 , 203 \times 0 , 5133} = 37 , 2$$

Preparation of Compositions Comprising POSS and Plasticizer (DINP)

The reaction mixtures were added to a round bottom flask to which diisononyl phthalate (DINP) was added. The reactions solvents were removed under vacuum to give only POSS and DINP. The obtained compositions are highly advantageous in obtaining a homogenous blend of the POSS with a suitable monomer.

Depending on the polymer in which the POSS is to be used, the composition may also be emulsified by mixing with water. These emulsions may advantageously be used in water-based dispersions of various monomers, i.e. latex, such as PVC and acrylates.

Test of Exemplary POSS Compounds as Flame Retardants

The flame retarding properties of the exemplary POSS compounds were tested according to the ISO11925-2 single flame source fire test, https://www.iso.org/obp/ui/#iso:std:iso:11925:-2:ed-3:v1:en

To obtain specimens suitable for the fire test, some exemplary compounds (SF453, SF457, SF468, SF506, SF460, SF456) and some comparative compounds (SF406, SF427, SF205, SF228) were used as additives in PVC to obtain suitable strips of polymeric film having a thickness of 1.3 to 1.6 mm. Each specimen was obtained by curing a mixture of the respective exemplary compound with PVC monomer (P1412 E-PVC), diisononyl phthalate (DINP), aluminium trihydrate (ATH) and stabilizer (Baerostab UBZ 660-4 RF) in a weight ratio of 1:100:50:20:3.

The exemplary POSS compounds according to the invention displayed good to excellent flame-retardant properties in the ISO11925-2 test, see table 1. In table 1, the amount of the various reactants is given as mol %.

The experimental results from the ISO11925-2 flame test reveals that the POSS compounds having a combination of long hydrocarbon chains, e.g. as obtained by the addition of various fatty acids to primary amine groups, phthalimide residues and short hydrocarbon chains without any amino-functionality have highly advantageous properties as flame retardants.

In a second series of specimens suitable for the fire test, other exemplary compounds (FN400151, FN400126, FN400127) and a comparative compound (FN400120) were used as additives in polyol. To obtain suitable sample of foam methylene diphenyl diisocyanate (MDI) was mixed with polyol and water in weight ratio 34:20:1.

Only flame height was measured according to ISO11925-2, but other flame parameters, such as the pass/fail test, are not relevant for this material.

The exemplary POSS compounds according to the invention displayed a significantly lower flame height than the comparative examples and provide good to excellent flame-retardant properties in the ISO11925-2 test, see table 2. In table 2, the amount of the various reactants is given as mol %.

TABLE 1

| | SF453 | SF457 | SF468 | SF506 | SF460 | SF406 | SF456 | SF427 | SF205 | NO POSS | SF228 | SF400 |
|---|---|---|---|---|---|---|---|---|---|---|---|---|
| Silanes used | | | | | | | | | | | | |
| (3-aminopropyl)triethoxy silane | 50 | 50 | 20 | 50 | 50 | 100 | 50 | 100 | 100 | | 100 | 50 |
| propyltriethoxy silane | 50 | 50 | | | 50 | | 50 | | | | | |
| propyltrimethoxy silane | | | | | | | | | | | | |
| vinyltriethoxy silane | | | | 50 | | | | | | | | |
| phenyltriethoxy silane | | | 80 | | | | | | | | | |
| Octyltriethoxy silane | | | | | | | | | | | | 50 |
| POSS REACTED WITH | | | | | | | | | | | | |
| salisylic acid | | | | | | | | | 75 | | 50 | |
| stearic acid (C18) | 25 | 15 | 12.5 | | | | 50 | 100 | | | 50 | 25 |
| lauric acid (C12) | | | | | | | | | | | | |
| behenic acid (C22) | | | | | | 25 | | | 25 | | | |
| phthalic anhydride (FSA) | 25 | 35 | 7.5 | 25 | 25 | 50 | | | | | | 25 |
| soya acid (unsaturated) | | | | 25 | 25 | | | | | | | |
| acetic anhydride | | | | | | 25 | | | | | | |
| average burn time (3 samples) | 5.7 | 4.7 | 12 | 6 | 3.7 | 13.3 | 6.7 | 6 | 9.3 | Comp. | 6.3 | 2.0 |
| SAG | NO | NO | NO | NO | NO | YES | NO | YES | YES | YES | YES | YES |
| flame height less than 150 mm | YES | YES | YES | YES | YES | NO | YES | NO | NO | NO | NO | YES |
| PASS/FAIL ISO11925 | PASS | PASS | PASS | PASS | PASS | FAIL | PASS | FAIL | FAIL | FAIL | FAIL | PASS |
| appearance at 20 wt % in DINP | thin | thin | thin | solid | thin | sep. | solid | solid | cloudy | | solid | thin |
| (RT) | liquid | liquid | liquid | gel | liquid | | gel | gel | liquid | | gel | liquid |

TABLE 2

| | FN400120 | FN400126 | FN400127 | FN400151 | NO POSS |
|---|---|---|---|---|---|
| Silane used | | | | | |
| (3-aminopropyl)triethoxy silane | 100 | 75 | 50 | 50 | |
| propyltriethoxy silane | | 25 | 50 | 50 | |
| POSS REACTED WITH | | | | | |
| salisylic acid | 50 | 25 | | | |
| phtalic anhydride (FSA) | 25 | 25 | 25 | 40 | |
| acetic anhydride | 25 | 25 | 25 | 10 | |
| Flame height (mm) | 70 | 60 | 65 | 30 | 80 |

1. A silsesquioxane of formula:
(R1SiO1,5)x(R2SiO1,5)y(R3SiO1,5)z, wherein
x≥1, y≥1, z≥1, and x+y+z=6, 8, 10 or 12;
R₁ is L₁-phthalimide, wherein L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and the phthalimide is optionally substituted by one or more halogen, C₁-C₆ alkyl, —COOH, —OH or —NO₂;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens;
and
R₃ is L₂-NH—CO—R₄, wherein L₂ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and wherein R₄ is a C₁-C₃₄ alkyl or a C₈-C₃₄ alkene.

2. A silsesquioxane according to claim 1, wherein L₁ is C₁-C₆ alkyl, phenyl or vinyl.

3. A silsesquioxane according to claim 1, wherein R₂ is a C₁-C₁₈ alkyl, a C₁-C₇ alkene or a phenyl group, optionally substituted by one or more halogens.

4. A silsesquioxane according to claim 1, wherein R₂ is a C₁-C₈ alkyl, a C₁-C₅ alkene or a phenyl group, optionally substituted by one or more halogens.

5. A silsesquioxane according to claim 1, wherein L₂ is C₁-C₆ alkyl, phenyl or vinyl.

6. A silsesquioxane according to claim 1, wherein R₄ is a C₁₂-C₂₄ alkyl or a C₁₂-C₂₄ alkene.

7. A silsesquioxane according to claim 1, wherein R₄ is a C₁₈-C₂₂ alkyl or a C₁₈-C₂₂ alkene.

8. A silsesquioxane according to claim 1, wherein L₁ and L₂ are identical.

9. A silsesquioxane according to claim 1, wherein L₁ and L₂ are both C₁-C₆ alkyl, and R₂ is a C₁-C₈ alkyl, a C₁-C₇ alkene or a phenyl group.

10. A silsesquioxane of formula:
(H₂N-L₁-SiO_{1,5})ₓ(R₂SiO_{1,5})_{y}, wherein
x≥2, y≥2, and x+y=6, 8, 10 or 12;
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens.

11. Use of a silsesquioxane according to claim 1 as a flame-retardant additive.

12. A plasticizer composition comprising:
c) 50-99 wt % of a plasticizer; and
d) 1-50 wt % of a silsesquioxane of formula:
(R1SiO1,5)x(R2SiO1,5)y(R3SiO1,5)z, wherein
x≥1, y≥1, z≥1, and x+y+z=6, 8, 10 or 12;
R₁ is L₁-phthalimide, wherein L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and the phthalimide is optionally substituted by one or more halogen, C₁-C₆ alkyl, —COOH, —OH or —NO₂;
R₂ is a residue selected from the group consisting of saturated or unsaturated C₁-C₁₈ hydrocarbon radicals which may be straight, branched or cyclic: wherein the carbon chains of said residues optionally include one or more oxygens and are optionally substituted by one or more halogens;
and
R₃ is L₂-NH—CO—R₄, wherein L₂ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen; and wherein R₄ is a C₁-C₃₄ alkyl or a C₅-C₃₄ alkene;
wherein
the plasticizer is selected from a dicarboxylic/tricarboxylic ester-based plasticizers selected from the group of phthalates, 1,2-cyclohexane dicarboxylates, trimellitates, adipates, sebacates, maleates, terephthalates or any combination thereof, and
wherein the combined wt % of the plasticizer and the silsesquioxane is within the range of 95-100 wt % of the total weight of the plasticizer composition.

13. A polymeric material comprising a silsesquioxane according to claim 1.

14. A method of manufacturing a silsesquioxane or a composition comprising the steps of:
condensing a compound of formula H₂N-L₁-Si(OR₅)₃ and a compound of formula R₂Si(OR₆)₃ in a mole ratio of 0.25 to 4, wherein
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens; and
each of R₅ and R₆ are any of —CH₃ and —CH₂CH₃;
obtaining an intermediate silsesquioxane of formula (H₂N-L₁-SiO_{1,5})ₓ(R₂SiO_{1,5})_{y}, wherein
x≥2, y≥2, and x+y=6, 8, 10 or 12;
reacting the intermediate silsesquioxane with a first compound of formula LG-CO—R₄, wherein LG is a suitable leaving group and R₄ is a C₁-C₃₄ alkyl or a C₅-C₃₄ alkene, and a second compound being phthalic anhydride optionally substituted by one or more halogen, C₁-C₈ alkyl, —COOH, —OH or —NO₂; and
obtaining a silsesquioxane according to claim 1.

15. A method of manufacturing a silsesquioxane or a composition comprising the steps of:
condensing a compound of formula H₂N-L₁-Si(OR₅)₃ and a compound of formula R₂Si(OR₆)₃ in a mole ratio of 0.25 to 4, wherein
L₁ is a residue selected from the group consisting of saturated or unsaturated C₁-C₈ hydrocarbon radicals which may be straight, branched or cyclic; and substituted or non-substituted arylene; wherein the carbon chains of said residues optionally include one or more of the elements oxygen and nitrogen;
R₂ is a residue selected from the group consisting of saturated or unsaturated C₁-C₁₈ hydrocarbon radicals which may be straight, branched or cyclic; wherein the carbon chains of said residues optionally include one or more oxygens and are optionally substituted by one or more halogens; and
each of R₅ and R₆ are any of —CH₃ and —CH₂CH₃;
obtaining a silsesquioxane according to claim 10.

16. A silsesquioxane obtainable by the method according to claim 1.

17. A polymeric material comprising a plasticizer composition according to claim 12.

18. A silsesquioxane obtainable by the method according to claim 15.
